(19) United States
(12) Patent Application Publication
(10) Pub. No.: US 2013/0109393 A1
(43) Pub. Date: May 2, 2013

(54) METHODS AND APPARATUS FOR INTER-RAT HANDOVER BY A MULTIMODE MOBILE STATION

(71) Applicants: Guangming Shi, San Diego, CA (US); Tom Chin, San Diego, CA (US); Kuo-Chun Lee, San Diego, CA (US)

(72) Inventors: Guangming Shi, San Diego, CA (US); Tom Chin, San Diego, CA (US); Kuo-Chun Lee, San Diego, CA (US)

(73) Assignee: QUALCOMM Incorporated, San Diego, CA (US)

(21) Appl. No.: 13/283,233

(22) Filed: Oct. 27, 2011

(51) Int. Cl. H04W 24/00; H04W 36/08

(52) U.S. Cl. 455/437; 455/456.6

(57) ABSTRACT

Certain aspects of the present disclosure present a method for detecting whether or not a base station (or a mobile station served by the base station) is in the border of a network. The proposed algorithm may be used to determine if a mobile station should handover to a different wireless network.

### TECHNICAL FIELD

Certain aspects of the present disclosure generally relate to wireless communication and, more particularly, handover between two radio access technologies (RATs) by a multimode mobile station.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division—Code Division Multiple Access (TD-CDMA), and Worldwide Interoperability for Microwave Access (WiMAX).

As the demand for mobile broadband access continues to increase, research and development continue to advance the UMTS technologies not only to meet the growing demand for mobile broadband access, but to advance and enhance the user experience with mobile communications.

### SUMMARY

Certain aspects of the present disclosure provide a method for determining whether a mobile station is at the border of a wireless network. The method generally includes receiving a message providing locations of a serving base station and one or more neighboring base stations of the same radio access technology (RAT), determining angles of the one or more neighboring base stations of the same RAT with respect to the serving base station based on the locations of the serving base station and the one or more neighboring base stations, and determining whether or not the mobile station is at the border of the wireless network based on the determined angles.

Certain aspects of the present disclosure provide a method to increase performance of border cell scanning and handover. The method generally includes scanning neighboring base stations of a first wireless network utilizing a first radio access technology (RAT) to determine whether a mobile station is at a border of the first wireless network, scanning base stations of one or more other networks and neighboring base stations within the first wireless network for multi-mode mobile stations if the mobile station is determined to be at the border of the first wireless network, and determining whether or not to handover to a second wireless network.

Certain aspects of the present disclosure provide an apparatus for wireless communications. The apparatus generally includes means for receiving a message providing locations of a serving base station and one or more neighboring base stations of the same radio access technology (RAT), means for determining angles of the one or more neighboring base stations of the same RAT with respect to the serving base station based on the locations of the serving base station and the one or more neighboring base stations, and means for determining whether or not the apparatus is at a border of a wireless network based on the determined angles.

Certain aspects of the present disclosure provide an apparatus for wireless communications. The apparatus generally includes means for scanning neighboring base stations of a first wireless network utilizing a first radio access technology (RAT) to determine whether the apparatus is at a border of the first wireless network, means for scanning base stations of one or more other networks and neighboring base stations within the first wireless network for multi-mode apparatuses if the apparatus is determined to be at the border of the first wireless network, and means for determining whether or not to handover to a second wireless network.

Certain aspects provide a computer-program product for determining whether a mobile station is at a border of a wireless network, comprising a computer-readable medium having instructions stored thereon, the instructions being executable by one or more processors. The instructions generally include instructions for receiving a message providing locations of a serving base station and one or more neighboring base stations of the same radio access technology (RAT), instructions for determining angles of the one or more neighboring base stations of the same RAT with respect to the serving base station based on the locations of the serving base station and the one or more neighboring base stations, and instructions for determining whether or not the mobile station is at the border of the wireless network based on the determined angles.

Certain aspects provide a computer-program product to increase performance of border cell scanning and handover, comprising a computer-readable medium having instructions stored thereon, the instructions being executable by one or more processors. The instructions generally include instructions for scanning neighboring base stations of a first wireless network utilizing a first radio access technology (RAT) to determine whether a mobile station is at a border of the first wireless network, instructions for scanning base stations of one or more other networks and neighboring base stations within the first wireless network for multi-mode mobile stations if the mobile station is determined to be at the border of the first wireless network, and instructions for determining whether or not to handover to a second wireless network.

Certain aspects of the present disclosure provide an apparatus for wireless communications. The apparatus generally includes at least one processor and a memory coupled to the at least one processor. The at least one processor is generally configured to receive a message providing locations of a serving base station and one or more neighboring base stations of the same radio access technology (RAT), determine angles of the one or more neighboring base stations of the same RAT with respect to the serving base station based on the locations of the serving base station and the one or more neighboring base stations, and determine whether or not the apparatus is at a border of a wireless network based on the determined angles.

Certain aspects of the present disclosure provide an apparatus for wireless communications. The apparatus generally includes at least one processor and a memory coupled to the at least one processor. The at least one processor is generally configured to scan neighboring base stations of a first wireless network utilizing a first radio access technology (RAT) to determine whether the apparatus is at a border of the first wireless network, scan base stations of one or more other networks and neighboring base stations within the first wireless network for multi-mode apparatuses if the apparatus is determined to be at the border of the first wireless network, and determine whether or not to handover to a second wireless network.

### BRIEF DESCRIPTION OF THE DRAWINGS

So that the manner in which the features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example wireless communication system, in accordance with certain aspects of the present disclosure.

FIG. 2 illustrates various components that may be utilized in a wireless device in accordance with certain aspects of the present disclosure.

FIG. 3 illustrates an example transmitter and an example receiver that may be used within a wireless communication system that utilizes orthogonal frequency-division multiplexing/multiple access (OFDM/OFDMA) technology in accordance with certain aspects of the present disclosure.

FIG. 4 illustrates an example network topology in which two wireless networks are located in adjacent geographic areas, in accordance with certain aspects of the present disclosure.

FIG. 5 illustrates example operations for determining whether or not a multimode MS is at the border of a wireless network, in accordance with certain aspects of the present disclosure.

FIG. 6 illustrates a tangent plane, in accordance with certain aspects of the present disclosure.

FIG. 7 illustrates an example network topology of a plurality of base stations in a network, in accordance with certain aspects of the present disclosure.

FIG. 8 illustrates an example table including values for a serving BS and its neighboring BSs based on the proposed border detection algorithm, in accordance with certain aspects of the present disclosure.

FIG. 9 illustrates example operations that may be performed by a mobile station to increase performance of border cell scanning and handover, in accordance with certain aspects of the present disclosure.

FIG. 10 illustrates an example network in which a MS is moving away from a serving BS, in accordance with certain aspects of the present disclosure.

### DETAILED DESCRIPTION

Certain aspects are described herein with reference to the drawings, wherein like reference numerals are used to refer to like elements throughout. In the following description, for purposes of explanation, numerous specific details are set forth in order to provide a thorough understanding of certain aspects. However, it may be that such aspect(s) can be practiced without these specific details. In other instances, well-known structures and devices are shown in block diagram form in order to facilitate describing certain aspects.

### An Example Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

One example of a communication system based on an orthogonal multiplexing scheme is a WiMAX system. WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX is based on OFDM and OFDMA and offers the full mobility of cellular networks at broadband speeds.

IEEE 802.16 is an emerging standard organization to define an air interface for fixed and mobile broadband wireless access (BWA) systems. These standards define at least four different physical layers (PHYs) and one media access control (MAC) layer. The OFDM and OFDMA physical layer of the four physical layers are the most popular in the fixed and mobile BWA areas respectively.

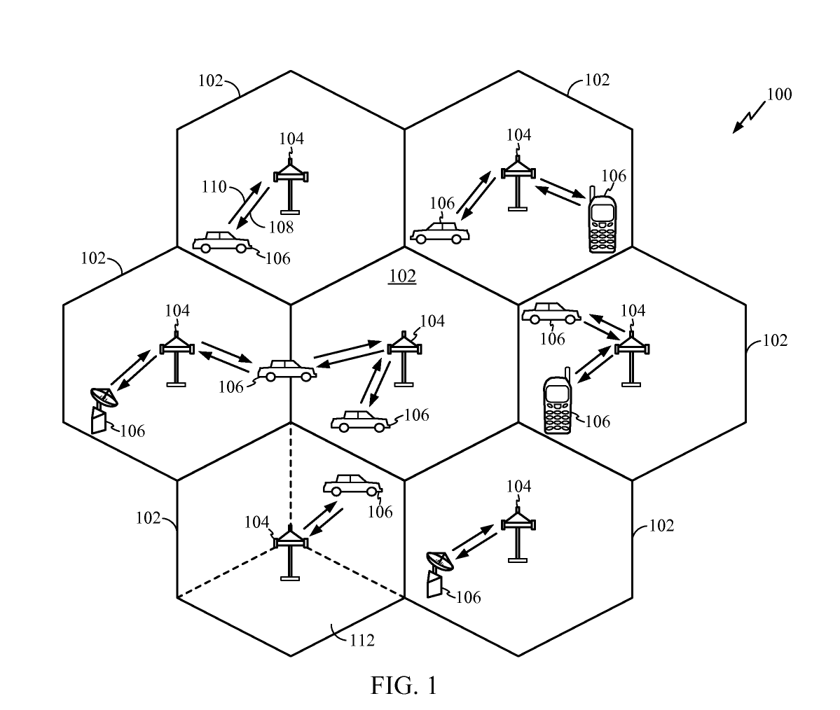

FIG. 1 illustrates an example of a wireless communication system 100 in which certain aspects of the present disclosure may be employed. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. User terminals 106 may be fixed (i.e., stationary) or mobile. User terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers, etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

Cell 102 may be divided into multiple sectors 112. Sector 112 is a physical coverage area within a cell 102. Base stations 104 within a wireless communication system 100 may utilize antennas that concentrate the flow of power within a particular sector 112 of the cell 102. Such antennas may be referred to as directional antennas.

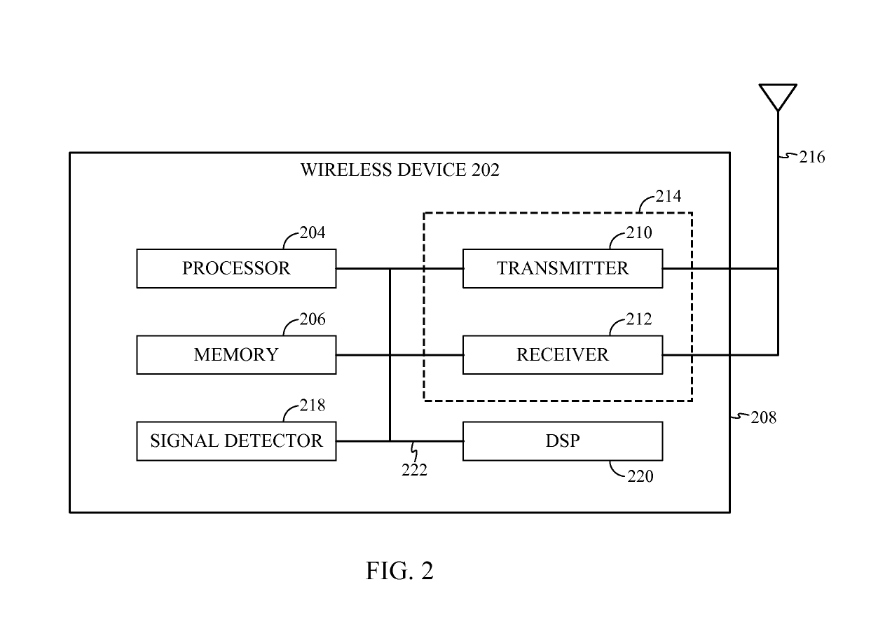

FIG. 2 illustrates various components that may be utilized in a wireless device 202 that may be employed within the wireless communication system 100. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to processor 204. A portion of memory 206 may also include non-volatile random access memory (NVRAM). Processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy per pseudonoise (PN) chips, power spectral density and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

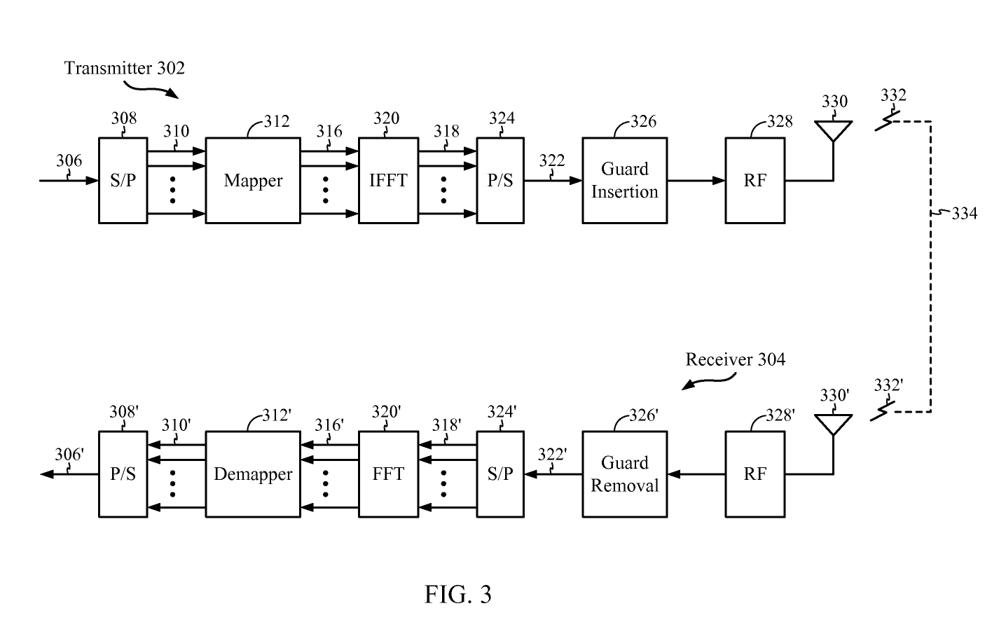

FIG. 3 illustrates an example of a transmitter 302 that may be used within a wireless communication system 100 that utilizes OFDM/OFDMA. Portions of transmitter 302 may be implemented in transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), and the like. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Ns, is equal to N_{cp} (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless device 202 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312 thereby outputting N parallel data streams 310′. A P/S converter 308′ may combine the N parallel data streams 310′ into a single data stream 306′. Ideally, this data stream 306′ corresponds to the data 306 that was provided as input to the transmitter 302. Note that elements 308′, 310′, 312′, 316′, 320′, 318′ and 324′ may all be found in a baseband processor.

### An Example Method to Find a Trigger Condition of Inter-Rat Handover

Certain aspects of the present disclosure present an algorithm for detecting whether or not a BS (or a MS served by the BS) is in the border of a network. The proposed algorithm may be used to determine if a mobile station should handover to a different wireless network.

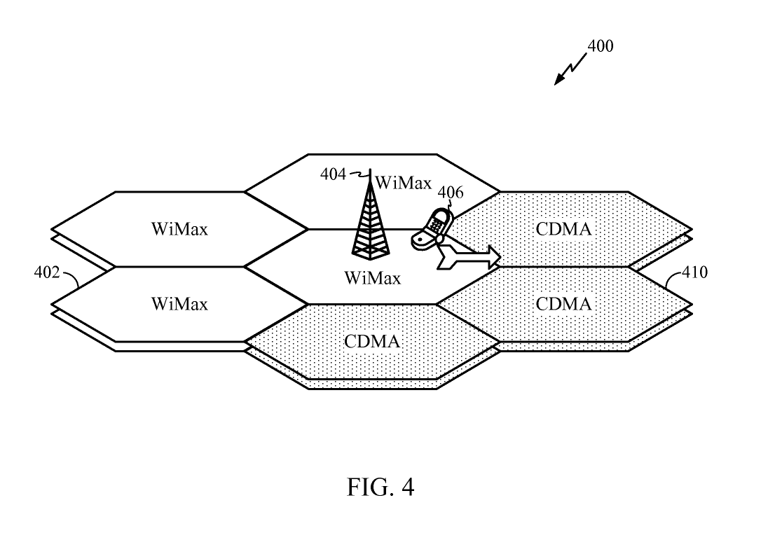

FIG. 4 illustrates an example network topology in which two wireless networks are located in adjacent geographic areas. In general, the wireless networks may use any radio access technology (e.g., WiMAX, CDMA, UMTS, LTE, and the like). In this example, a WiMAX network 402 and a CDMA network 410 are illustrated. A multi-mode MS 406 may communicate with a serving base station 404 in one of the networks (e.g., the WiMAX network 402). If the multi-mode MS is in the border of the wireless network, the MS may start to prepare for a handover to another network that utilizes a different radio access technology (RAT), such as the CDMA network 410. One trigger condition for handover may be when the MS detects a weak signal from the serving BS 404.

The MS may also check signal strength of other neighboring BSs of the same RAT. If neither the serving BS, nor the neighboring BSs have a strong signal, the MS may trigger a handover to another RAT. However, the handover condition based on signal strength may not be accurate due to signal strength variations. In addition, the handover may be triggered too late in time, since some existing inter-RAT handover procedures may use some setup procedures. For example, the MS may communicate with the second network for the setup procedures using a message tunnel through its current network (e.g., the WiMAX network).

Certain aspects propose a new method to detect that the serving BS is in the border of a network and therefore the inter-RAT handover may trigger. For certain aspects, a Location Based Service Advertisement (LBS-ADV) message as defined in WiMAX standards may be used to check the network topology. If the MS detects that the serving BS is in the border of the current network, the MS may decide that an inter-RAT handover may be needed in future.

### Border BS detection

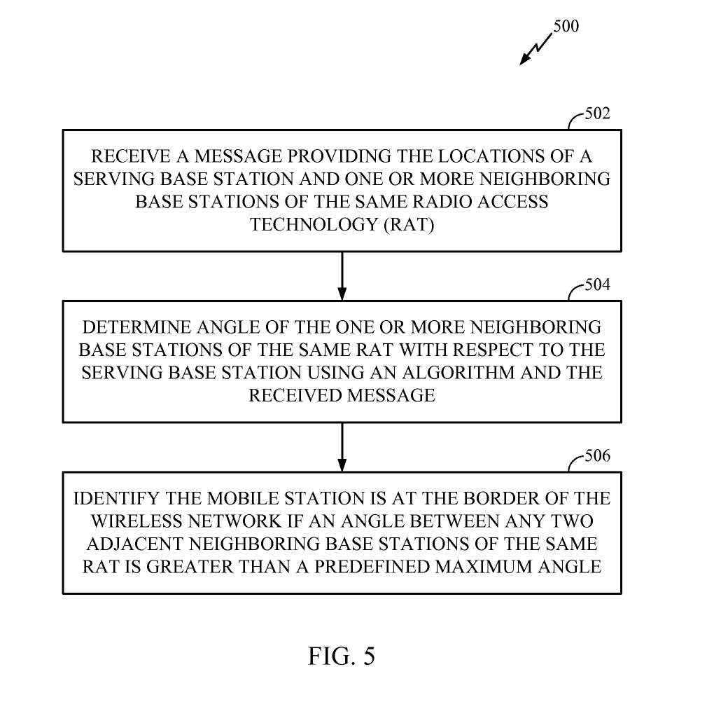

FIG. 5 illustrates example operations 500 for determining whether or not a multimode MS is at the border of a wireless network.

At 502, the multimode MS may receive a message providing the locations of a serving base station and one or more neighboring base stations of the same RAT. At 504, the multimode MS may determine angle of the one or more neighboring base stations of the same RAT with respect to the serving base station using an algorithm (e.g., border detection algorithm) and the received message.

At 506, the MS may identify that it is at the border of the wireless network if an angle between any two adjacent neighboring base stations of the same RAT is greater than a predefined maximum angle.

The exact format of the message received, at 502, may depend on an exact implementation. Some wireless standards define a location information message (e.g., the Location Based Service Advertisement (LBS-ADV) message in the WiMAX standard) that may include location of the serving BS and the neighboring BSs. The location information may include an absolute position, (e.g., latitude (in degree), longitude (in degree), and altitude (in meter)). The location information may also include relative position, (e.g., distance north of the reference point (in meters), distance east of the reference point (in degrees), and distance above the reference point (in meters)).

Certain aspects of the present disclosure may allow detection that the serving BS is in the border of a network, if all neighbor BSs of the same network are located on one side of the serving BS.

In order to detect if a mobile station (or its serving BS) is in the border of a network, various types of border detection algorithms may be used. The following illustrates example operations of one such algorithm.

In a first step, the MS receives the location information message (e.g., LBS-ADV message) which includes the location of the serving BS and all neighbor BSs. For simplicity, it may be assumed that the index for serving BS is 0 and the indices of other neighbor BS in the message are 1, 2 . . . , n. As an example, a 3-sector cell site with co-located BSs may be considered. In this example, the calculations for only one of the three BSs are shown. However, one skilled in the art would easily extend the calculations for other BSs.

In a subsequent step of the border detection algorithm, the location may be translated into a vector as follows. If absolute positions are reported in the location information, the location information may be translated into a vector using the following equation:

(x,y)=(R*cos(latitude)*longitude*R/180, R*latitude*π/180) (1a)

If relative positions are reported in the location information, the location information may be translated into a vector using the following equation:

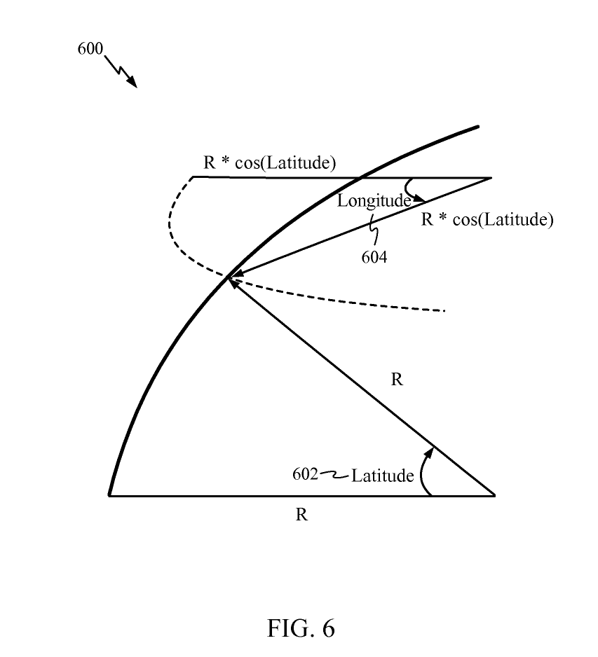

(x,y)=(distance east of reference point, distance north of reference point) (1b)

where R is the radius of the earth, (e.g., 6378 km), direction x may point to the east, and direction y may point to the north. Note that the altitude may not be considered in the decision. For the absolute position, a tangential plane (as shown in FIG. 6) may be considered to find the (x,y) in equation (1a).

FIG. 6 illustrates an example tangential plane, in accordance with certain aspects of the present disclosure. As illustrated, the latitude 602 and longitude 604 may be mapped to angles in the tangent plane.

In a subsequent step of the border detection algorithm, distance between neighbor BS with index i and the serving BS may be calculated, as follows:

D(i)=\sqrt{(xᵢ−x₀)¹+(yᵢ−y₀)²} (2)

In a subsequent step the border detection algorithm, only neighbor BSs that are not very far from the serving BS and not too close to the serving BS may be considered, as follows:

S={i: D_{H}≧D(i)≦D_{L}} (3)

where S represents the set of BSs that meet the above condition. The distance threshold D_{H} is to avoid considering BSs that are too far from the serving BS. The distance threshold D_{L} is to avoid considering BSs that are very close to the serving BS (e.g., the BSs that are physically co-located with the serving BS or a femto BS in the coverage area of the serving BS).

In a subsequent step of the border detection algorithm, a normalized vector may be calculated for all the neighbor BSs in the set S, as follows:

(uᵢ,vᵢ)=((xᵢ, yᵢ)−(x₀, y₀))/D(i) (4)

Next, the angle θᵢ of the normalized vector (uᵢ, vᵢ) may be calculated, as follows:

(uᵢ,vᵢ)=(cos(θᵢ), sin(θᵢ)) (5)

where the angle may be in degrees and angle=0 may point to the east direction, and where

360>θᵢ≦0

For certain aspects, all the angles of all the neighbor BSs in the set S may be sorted in descending order in the set A, assuming that the identical values only appear once:

A={α(1), α(2), . . . , α(m)} (6)

where α(i)≧α(j), if i>j.

In a subsequent step of the border detection algorithm, the maximum difference between adjacent angles in the set A may be calculated as follows:

β=max{max_{m-2≧i≧i}{α(i)−α(i+1)}, 2*π+(α(m)−α(1))} (7)

Next, the maximum difference of the adjacent angels may be compared with a threshold to determine if the serving BS is in the border cell of the network. The serving BS is in the border cell if and only if the following condition holds:

β≧T (8)

For example, the threshold T may be equal to 180 degrees.

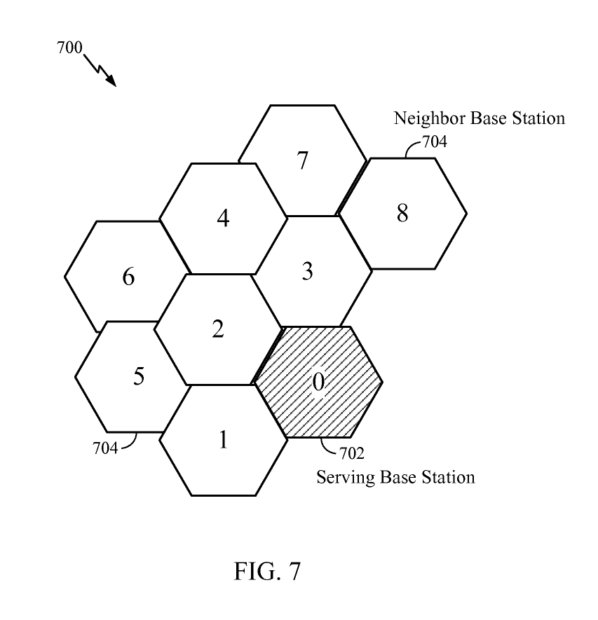

FIG. 7 illustrates an example network topology 700 of a plurality of base stations in a network. As illustrated, the serving base station 702 is in the border of the network and has index 0. The neighboring base stations 704 service different areas of the same network. The neighboring base station may have indices 1 through 8.

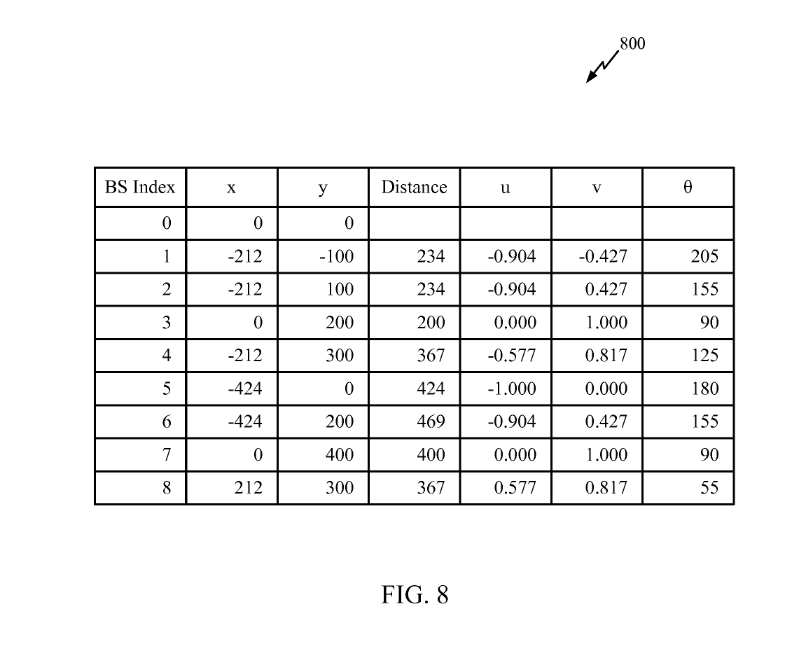

The proposed algorithm may be used to determine if the serving base station 702 is in the border of the network (e.g., WiMAX network). Example values that can be calculated using the border detection algorithm for the base stations in FIG. 7 are illustrated in the table in FIG. 8.

FIG. 8 illustrates an example table 800 including values for the (x,y) location of a serving BS and its neighboring BSs, distance from the serving BS, normalized vector and the angle (in degree), based on the proposed border detection algorithm, in accordance with certain aspects of the present disclosure. The angles may be ranked in descending order to find the set A={205, 180, 155, 125, 90, and 55} in which identical values may only appear once.

Using the values in table 800, β may be calculated as follows: β=max{(205-180), (180-155), (155-125), (125-90), (90-55), (360+(55-205))}=max{25, 25, 30, 35, 35, 210}=210.

Assuming that the threshold T is equal to 180 degrees, and β=210 is larger than the threshold. Therefore, the serving BS is indeed in the border of the network. This is because the large angle between BS1 and BS8 in reference to the serving BS may imply that all neighbor BSs are on one side of the serving BS.

### Scanning for Other RATs

Certain aspects of the present disclosure propose a procedure to increase the performance of scanning and handover between two different RATs. The proposed procedure may use the information that the current BS is a border cell. Certain aspects propose a scanning algorithm that may include the following operations.

If the current BS is not a border BS, then the MS may still proceed with regular processing in terms of scanning (e.g., scanning only the neighbor BSs in the same RAT).

If the current BS is a border BS, a multi-mode MS may scan for other RATs in addition to scanning for neighbor BSs in the same RAT when scanning is triggered. When a handover trigger occurs, the MS may use the signal measurements to decide whether or not to handover to a different RAT.

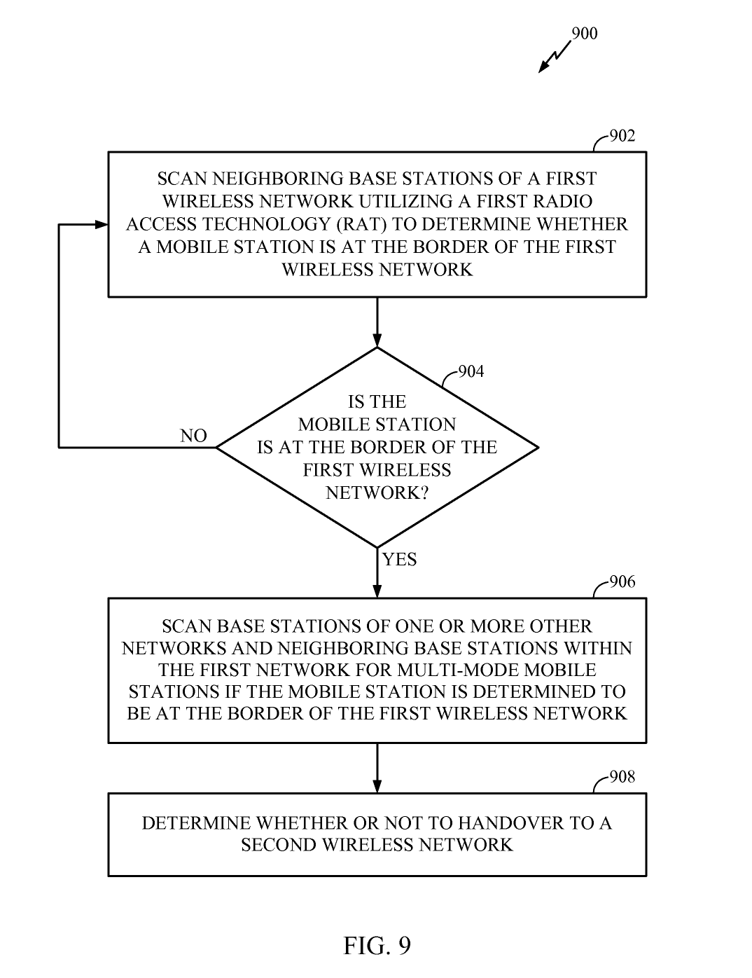

FIG. 9 illustrates example operations 900 that may be performed by a mobile station to increase performance of border cell scanning and handover. At 902, the MS may scan neighboring base stations of a first wireless network utilizing a first radio access technology (RAT) to determine whether it is at the border of the first wireless network. At 904, if the MS is not at the border of the first wireless network, the MS continues to scan (e.g., re-scan) neighboring base stations. At 906, the MS may scan base stations of one or more other networks and neighboring base stations within the first network (e.g., if the MS is a multi-mode mobile station) if the mobile station is determined to be at the border of the first wireless network. At 908, the MS determines whether or not to handover to a second wireless network. For example, the mobile station may determine whether it is moving towards or away from the border of the first wireless network. The mobile station may then decide whether or not to handover to the second wireless network.

### Handover to a Different RAT

Certain aspects uses MS location and moving direction as a trigger to handover to other RAT after MS is known to be served with a border BS of a network. A proposed handover procedure may involve the following operations.

The MS may find its moving direction by using the local GPS receiver or the D-TDOA (Downlink Time Difference of Arrival) provided by the network. The MS may calculate the (x,y) coordinate using the equations (1a) and (1b). For example, the moving direction may be found by comparing two positions at two time instances (e.g., t′ and t″), as follows:

(a,b)=[(x″, y″)−(x′, y′)]/\sqrt{(x″−x′)²+(y″−y′)²} (9a)

Also, MS location with reference to the serving BS at t″ may be assumed to be the absolute location of the serving BS in the location information message (e.g., the LBS-ADV message), as follows:

(c,d)=[(x″, y″)−(x₀, y₀)]/\sqrt{(x″−x₀)²(y″−y₀)²} (9b)

The MS may then calculate an angle between the moving direction and location direction with reference to the serving BS, as follows:

(a, b)=(cos(γ), sin(γ)) (10a)

(c, d)=(cos(φ), sin(φ)) (10b)

where the angles are in degrees and 360>γ, φ≦0.

MS may then determine whether or not it is moving away from the current network at the border cell by comparing its moving direction γ and φ in equation (10a) and (10b), and two BS directions that achieve the maximum in equation (7). This determination can be done by checking if the angle is within the two BS directions compared to margins H₁ or H₂.

If β=α(k)−α(k+1), where m−2≧k≧1, the MS may move away from the network if the following condition is satisfied:

α(k)−H1≧γ≧α(k+1)+H1 (11a)

It may be determined that the MS is located at one side, away from the network if the following condition is satisfied:

α(k)−H2≧φ≧α(k+1)+H2 (12a)

If β=2*π+(α(m)−α(1)):, the MS may be moving away from the network if either of the following two conditions is satisfied:

α(m)≧γ≧0 and α(m)−H1≧γ≧0 (11b)

360>γ≧α(1) and 360+α(m)−H1≧γ≧α(1)+H1 (11c)

The MS may be located on one side, away from the network if either of the following two conditions is satisfied:

α(m)≧φ≧0 and α(m)−H2≧φ≧0 (12b)

360>φ≧α(1) and 360+α(m)−H2≧φ≧α(1)+H2 (12c)

If the MS is at a border cell, located at one side, away from the network, and if the MS is moving away from the network, the MS may directly scan and handover to the other RAT when the signal received from the serving BS is weak, (e.g., downlink carrier to interference plus noise ratio (DL CINR) from the serving BS is less than a predefined value).

For example, in the table illustrated in FIG. 8, α(m)=55, and α(1)=205, and MS moving direction angle γ=270, and margin H₁=30. Therefore, the following values may be calculated:

360>γ=270≧α(1)=205,

360+55−30=385≧γ=270≧205+30=235

Therefore, in this case, it may be determined that the MS is moving away from the network.

Also, the angle of MS location with reference to the serving BS is angle φ=290, and margin H₂=30. Therefore, the following values may be calculated:

360>φ=290≧α(1)=205,

360+55−30=385≧φ=290≧205+30=235

Therefore, the MS is located at the side away from the network.

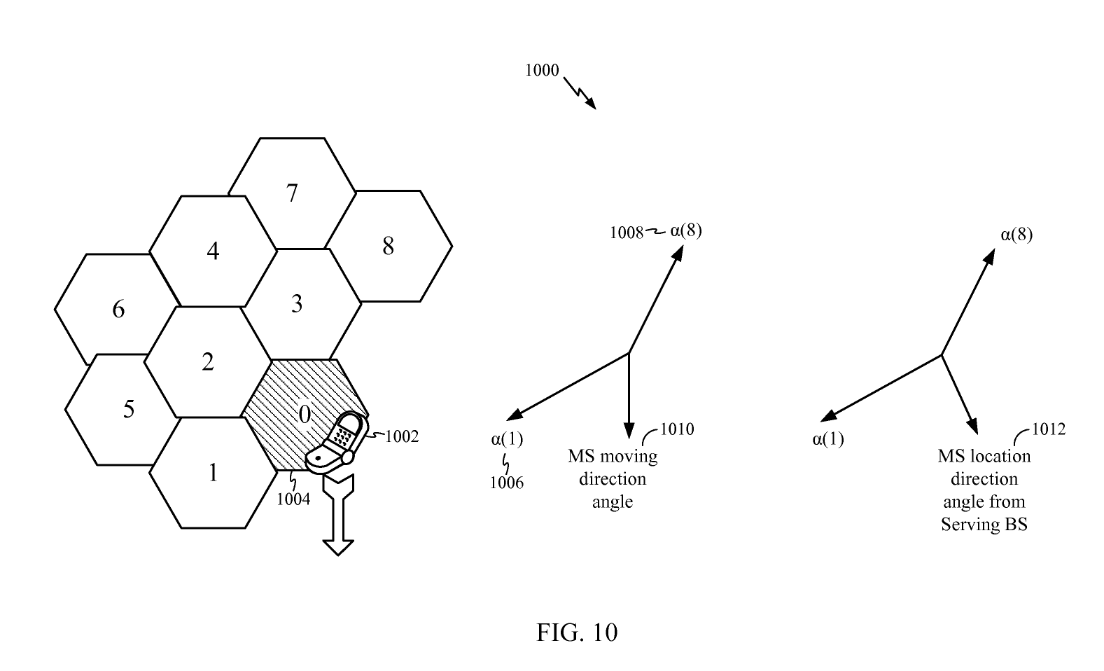

FIG. 10 illustrates an example network 1000 in which a MS 1002 is moving away from a serving BS 1004, in accordance with certain aspects of the present disclosure. As illustrated, the MS has angle α(1) 1006 with a neighbor base station with index 1 and angle α(8) 1008 with another neighbor base station with index 8. The moving direction 1010 of the MS is away from the network. The location direction angle 1012 from the serving base station is also shown in the figure.

Utilizing the proposed methods, the MS may determine whether or not it is located at the border of a network using the received location information (e.g., LBS-ADV) message. Using this information, the MS may avoid unnecessary scanning, and may speedup handover to a different network.

In addition, the moving direction and location of the MS may be used to detect if the MS is moving away from the network, and whether or not inter-RAT handover may be needed. The proposed method may improve performance of inter-RAT handover for a multi-mode MS.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for determining whether a mobile station is at a border of a wireless network, comprising:
receiving a message providing locations of a serving base station and one or more neighboring base stations of the same radio access technology (RAT);
determining angles of the one or more neighboring base stations of the same RAT with respect to the serving base station based on the locations of the serving base station and the one or more neighboring base stations; and
determining whether or not the mobile station is at the border of the wireless network based on the determined angles.

2. The method of claim 1, further comprising:
determining that the mobile station is at the border of the wireless network if an angle between any two adjacent neighboring base stations of the same RAT is greater than a predefined maximum angle.

3. The method of claim 1, wherein the angles are determined using an algorithm involving relative location information contained in the received message.

4. The method of claim 1, wherein the angles are determined using an algorithm involving absolute location information contained in the received message.

5. A method to increase performance of border cell scanning and handover, comprising:
scanning neighboring base stations of a first wireless network utilizing a first radio access technology (RAT) to determine whether a mobile station is at a border of the first wireless network;
scanning base stations of one or more other networks and neighboring base stations within the first wireless network for multi-mode mobile stations if the mobile station is determined to be at the border of the first wireless network; and
determining whether or not to handover to a second wireless network.

6. The method of claim 5, wherein determining whether or not to handover to the second wireless network comprises:
determining whether the mobile station is moving towards or away from the border of the first wireless network.

7. The method of claim 6, further comprising:
handing over to the second wireless network only if the mobile station is moving towards the border.

8. The method of claim 5, further comprising:
re-scanning the neighboring base stations if the mobile station is not determined at the border of the first wireless network.

9. An apparatus for wireless communications, comprising:
means for receiving a message providing locations of a serving base station and one or more neighboring base stations of the same radio access technology (RAT);
means for determining angles of the one or more neighboring base stations of the same RAT with respect to the serving base station based on the locations of the serving base station and the one or more neighboring base stations; and
means for determining whether or not the apparatus is at a border of a wireless network based on the determined angles.

10. The apparatus of claim 9, further comprising:
means for determining that the mobile station is at the border of the wireless network if an angle between any two adjacent neighboring base stations of the same RAT is greater than a predefined maximum angle.

11. The apparatus of claim 9, wherein the message is a Location Based Service Advertisement (LBS-ADV) message.

12. The apparatus of claim 9, wherein the angles are determined using an algorithm involving relative location information contained in the received message.

13. The apparatus of claim 9, wherein the angles are determined using an algorithm involving absolute location information contained in the received message.

14. An apparatus to increase performance of border cell scanning and handover, comprising:
means for scanning neighboring base stations of a first wireless network utilizing a first radio access technology (RAT) to determine whether the apparatus is at a border of the first wireless network;
means for scanning base stations of one or more other networks and neighboring base stations within the first wireless network for multi-mode apparatuses if the apparatus is determined to be at the border of the first wireless network; and
means for determining whether or not to handover to a second wireless network.

15. The apparatus of claim 14, wherein the means for determining whether or not to handover to the second wireless network comprises:
means for determining whether the apparatus is moving towards or away from the border of the first wireless network.

16. The apparatus of claim 15, further comprising:
means for handing over to the second wireless network only if the apparatus is moving towards the border.

17. The apparatus of claim 14, further comprising:
means for re-scanning the neighboring base stations if the apparatus is not determined at the border of the first wireless network.

18. A computer-program product for determining whether a mobile station is at a border of a wireless network, comprising a non-transitory computer readable medium having instructions stored thereon, the instructions being executable by one or more processors and the instructions comprising:
instructions for receiving a message providing locations of a serving base station and one or more neighboring base stations of the same radio access technology (RAT);
instructions for determining angles of the one or more neighboring base stations of the same RAT with respect to the serving base station based on the locations of the serving base station and the one or more neighboring base stations; and
instructions for determining whether or not the mobile station is at the border of the wireless network based on the determined angles.

19. The computer-program product of claim 18, further comprising:
instructions for determining that the mobile station is at the border of the wireless network if an angle between any two adjacent neighboring base stations of the same RAT is greater than a predefined maximum angle.

20. The computer-program product of claim 18, wherein the angles are determined using an algorithm involving relative location information contained in the received message.

21. The computer-program product of claim 18, wherein the angles are determined using an algorithm involving absolute location information contained in the received message.

22. A computer-program product to increase performance of border cell scanning and handover, comprising a non-transitory computer readable medium having instructions stored thereon, the instructions being executable by one or more processors and the instructions comprising:
instructions for scanning neighboring base stations of a first wireless network utilizing a first radio access technology (RAT) to determine whether a mobile station is at a border of the first wireless network;
instructions for scanning base stations of one or more other networks and neighboring base stations within the first wireless network for multi-mode mobile stations if the mobile station is determined to be at the border of the first wireless network; and
instructions for determining whether or not to handover to a second wireless network.

23. The computer-program product of claim 22, wherein the instructions for determining whether or not to handover to the second wireless network comprise:
instructions for determining whether the mobile station is moving towards or away from the border of the first wireless network.

24. The computer-program product of claim 23, further comprising:
instructions for handing over to the second wireless network only if the mobile station is moving towards the border.

25. The computer-program product of claim 22, further comprising:
instructions for re-scanning the neighboring base stations if the mobile station is not determined at the border of the first wireless network.

26. An apparatus for wireless communications, comprising at least one processor configured to:
receive a message providing locations of a serving base station and one or more neighboring base stations of the same radio access technology (RAT);
determine angles of the one or more neighboring base stations of the same RAT with respect to the serving base station based on the locations of the serving base station and the one or more neighboring base stations, and
determine whether or not the apparatus is at a border of a wireless network based on the determined angles; and
a memory coupled to the at least one processor.

27. An apparatus for wireless communications, comprising at least one processor configured to:
scan neighboring base stations of a first wireless network utilizing a first radio access technology (RAT) to determine whether the apparatus is at a border of the first wireless network,
scan base stations of one or more other networks and neighboring base stations within the first wireless network for multi-mode apparatuses if the apparatus is determined to be at the border of the first wireless network, and
determine whether or not to handover to a second wireless network; and
a memory coupled to the at least one processor.
